(19) United States
(12) Patent Application Publication
(10) Pub. No.: US 2010/0036858 A1
(43) Pub. Date: Feb. 11, 2010

(54) META FILE SYSTEM - TRANSPARENTLY MANAGING STORAGE USING MULTIPLE FILE SYSTEMS

(75) Inventor: Parveen K. Patel, Redmond, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/186,610

(22) Filed: Aug. 6, 2008

(51) Int. Cl. G06F 17/30

(52) U.S. Cl. 707/100; 707/E17.01; 707/E17.044

(57) ABSTRACT

Systems and methods are provided for the management of files across disparate file systems. In an illustrative operation, an exemplary computing environment comprises a file system management module, and an instruction set comprising at least one instruction to instruct the files system management module to manage, monitor, and control the storage/retrieval of a file across two or more disparate file systems operable on the exemplary computing environment managed using a unified name space. Illustratively, a file can be received by the file system management computing application and processed such that the file can be stored/managed (e.g., transparent to a user) on one of the operable two more disparate file systems according to one or more selected criteria. Further, the file system management application can monitor access patterns or attributes for individual files to generate the criteria used when storing/managing files across the two or more disparate files systems.

### BACKGROUND

Currently deployed computing environments allow for the use of one or more file systems that can be managed by an operating system for the computing environment. Generally, however, a storage device will be configured to use a single type of file system that is typically managed by a file system management application. Sometimes, however, advanced users, wanting to leverage certain benefits of one file system over another can operating system to run multiple types of file systems. In the context of running multiple file systems, a user is often relegated to choosing which files are stored on which file systems, which is arduous and can be a drain on valuable resources such as computing processing and, more importantly, the user's time.

Further, with current practices it is difficult to optimize a file system for different types of file access patterns or for different types of files. Generally, file systems can be more easily optimized for a single file access pattern or some attributes for a given set of files. For example, some file systems are optimized for reads, e.g., NTFS or Ext3, while others are optimized for writes, e.g., log-structured file system (LFS). Also, some file systems are optimized for small files while others are optimized for large files. A computing environment can support these varied files systems and file types but, with current practices, the user is often left to make the determination of where to store a file (i.e., on which of the varied file systems operable on a given computing environment). Such practice can be unreliable and can task a computing environment since a given file (e.g., a file having a small size) can be improperly stored in a less-than-optimal file system which can result in a wastage of resources.

In many cases a user of a computing environment is not provided a choice regarding where to store a particular file among cooperating disparate file systems. Instead, the operating system of a computing environment or some other application decides where the file resides. For example, with the WINDOWS operating system, some system files are stored in a particular directory (e.g., c:\windows\system32) and cannot be moved from this directory by a user of the operating system.

Furthermore, current practices generally charge the task of monitoring operational data representative of access patterns and/or attributes of files being stored to the individual file system management applications which, with current practices, do not share such operational data with each other. As a result, current practices do operate to optimize the storage/management of a file on a computing environment operating two or more disparate file systems on selected criteria (e.g., storing a first file having a first selected file attribute/access pattern on a first file system and storing a second file having a second selected file attribute/access pattern on a second file system). Instead the user is left making the file storage/management decision to a possible detriment of the optimal operation of the computing environment.

Also, with current practices, even if a user configured the operating environment with different file systems, the user has also to decide how much size to allocate for each type of file system. To overcome this difficulty, users divide their storage into volumes and format each volume with a single file system. If the size requirements for a given type of file system change, the user has to manually resize the volumes. This can be an error-prone and stressful task as an error can result in the loss of user data. Therefore, most users do not attempt to perform such task and accept sub-optimal use of their storage.

From the foregoing it is appreciated that there exists a need for systems and methods to ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide for the management of files across disparate file systems operable in an exemplary computing environment. In an illustrative operation, an exemplary computing environment comprises a file system management computing application, and an instruction set comprising at least one instruction to instruct the files system computing application to manage, monitor, and control the storage/retrieval of a file across two or more disparate file systems operable on the exemplary computing environment managed using a unified name space.

In an illustrative operation, data (e.g., a file) can be received by the file system management computing application and can be processed according to the at least one instruction of the instruction set such that the file can be stored/managed (e.g., transparent to a user) on one of the operable two or more disparate file systems according to one or more selected criteria. In the illustrative implementation and operation, the file system management application can monitor access patterns or attributes for individual files to generate the one or more selected criteria used when storing/managing files across the two or more disparate files systems.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of an illustrative processing environment in accordance with the herein described systems and methods.

FIG. 2 is a block diagram of exemplary components of an illustrative processing environment in accordance with the herein described systems and methods.

FIG. 3 is a block diagram of exemplary components of an illustrative computing environment deploying file management in accordance with the herein described systems and methods.

FIG. 4 is a block diagram of exemplary file systems operable in accordance with the herein described systems and methods.

FIG. 5 is a block diagram of an exemplary user interface in accordance with the herein described systems and methods.

FIG. 6 is a flow diagram of one example of an illustrative method performed when undertaking file management across disparate files systems in accordance with the herein described systems and methods.

FIG. 7 is a block diagram of an illustrative computing environment in accordance with the herein described systems and methods.

FIG. 8 is a block diagram of an illustrative networked computing environment in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Meta File-System—Transparent Management of Files Using Multiple File Systems:

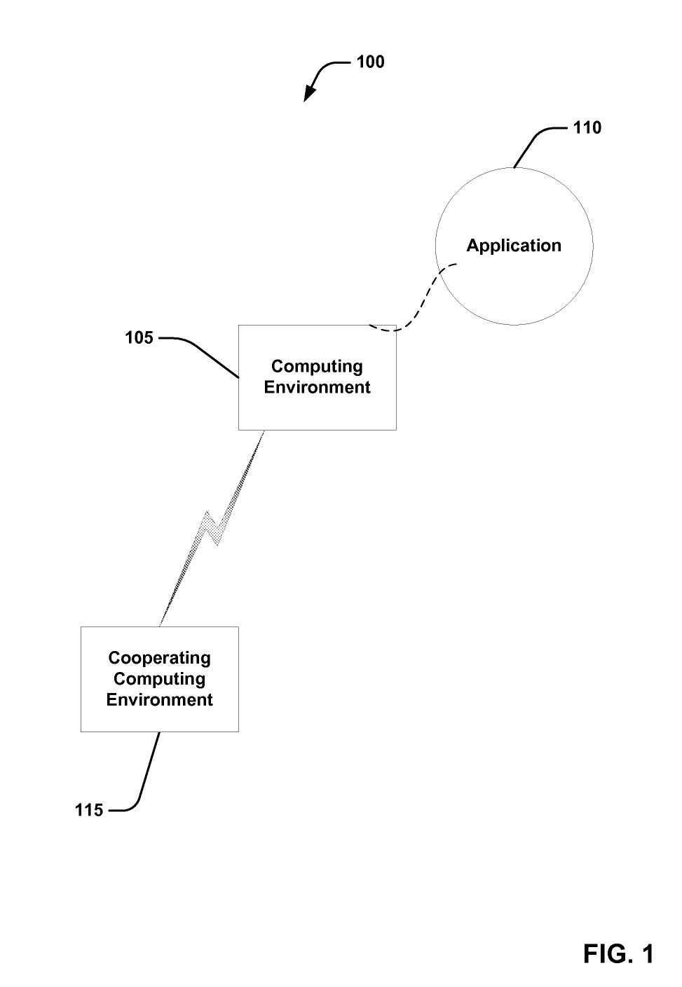

FIG. 1 is a block diagram of exemplary file system management environment 100. As is shown in FIG. 1, file system management environment comprises computing environment 105 operating application 110, and cooperating computing environment 115. In an illustrative implementation, application 110 can receive data (e.g., file) from cooperating computing environment 115. In an illustrative operation, the received file can be processed by application 110 (according to a selected file system management paradigm).

In an illustrative implementation, the file processed by application 110 can be provided by cooperating computing environment 115 cooperating with one or more data stores (not shown) having one or more file properties. In an illustrative operation, application 110 can operatively determine one or more file systems (not shown) cooperating with computing environment 105 on which to store the received file based on one or more file properties and one or more properties of the file system.

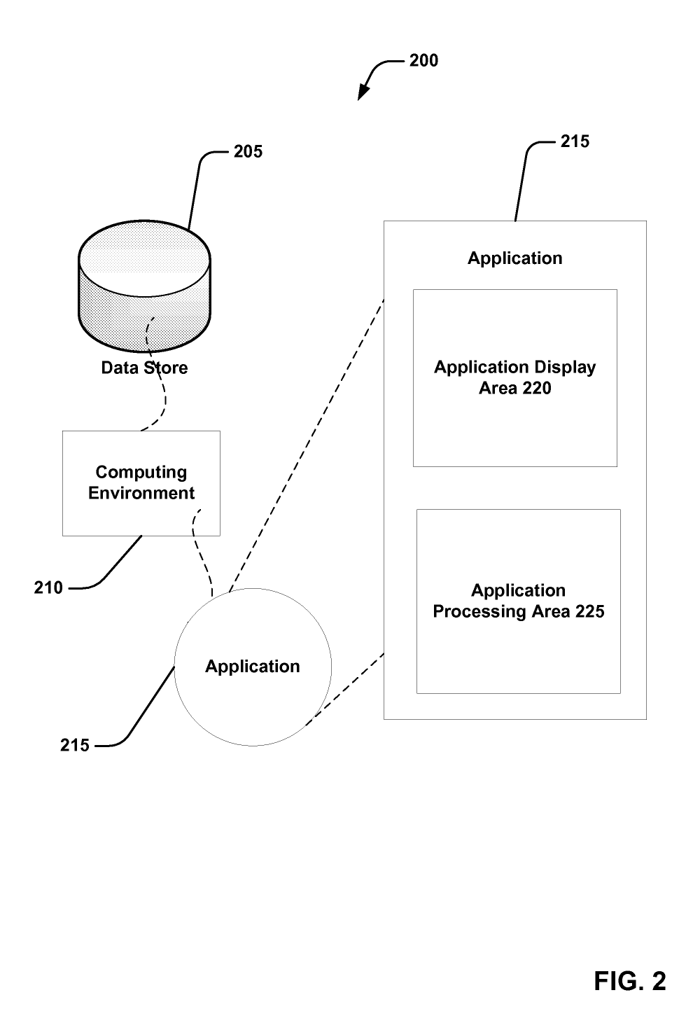

FIG. 2 is a block diagram of exemplary file system management environment 200. As is shown in FIG. 2, exemplary file system management environment 200 comprises computing environment 210 operating application 215 and data store 205. Further, as is shown, computing application 215 further comprises application display area 220 and application processing area 225. In an illustrative implementation, data (e.g., files) can be processed by application 215 using application processing area 225 for display, communication, navigation, and/or modification in application display area 220.

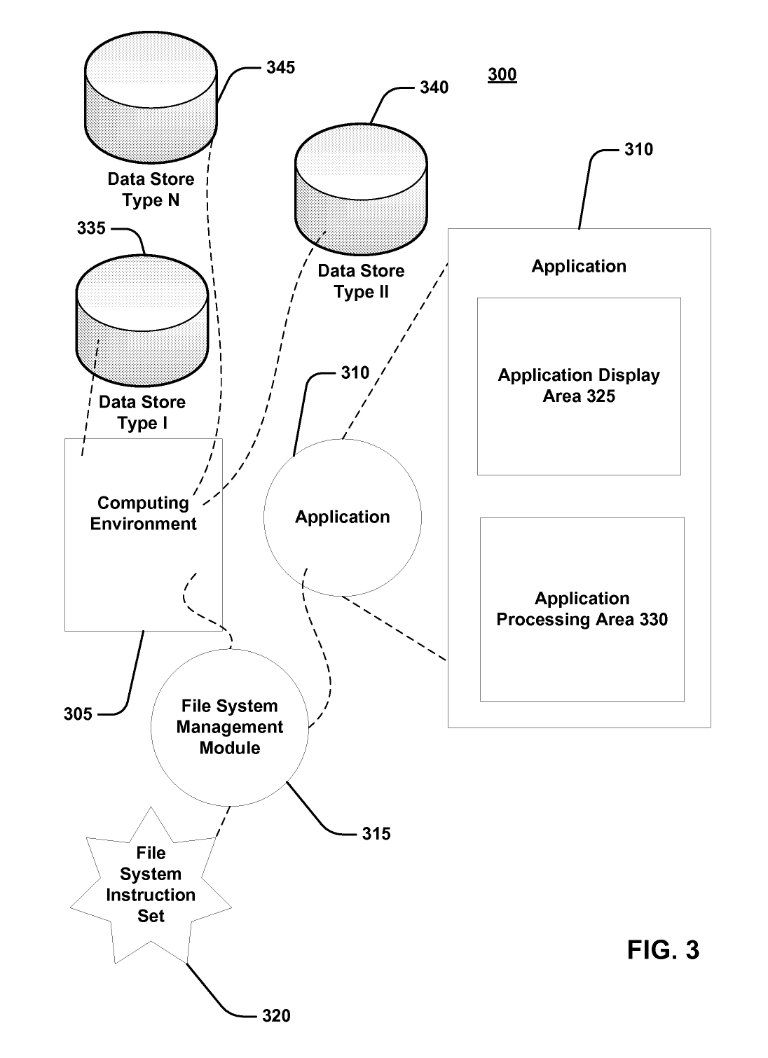

FIG. 3 is a block diagram of exemplary file system management environment 300. As is shown in FIG. 3, exemplary file system management environment 300 comprises computing environment 305 executing application 310 and cooperating with file system management module 315 executing cooperating with file system management instructions set 320, and data store 335 having first type I, data store 340 having a second type II, up to data store 345 having type N. Further, as is shown, file system management application 310 further comprises application display area 325 and application processing area 330.

In an illustrative implementation, a file can be processed by application 310 and can cooperate with file system management module 315 according to one or more instructions from file system instruction set 320. In the illustrative implementation, application 325 can cooperate with file system management module 315 to display file system management data for display, communication, navigation, and/or modification by application display area 320. In an illustrative operation, application 310 can receive a file for storage (or request a file to be stored) in one or more data stores 335 (or other cooperating electronic environment—not shown—capable of providing electronic data), 340, and 345 and store the received file according to one or more selected criteria.

In an illustrative implementation, a file system can manage storage (such as hard disks and USB flash drives) in terms of volumes. A volume can span multiple partitions on a single disk and or it can span multiple disks. Each volume can be formatted using one file system, such as NTFS, EXT3, HPFS or LFS. The file system can operatively decide how the file metadata and file contents are stored on the disk. Each file system volume has a namespace root (such as root on UNIX or c:\ on WINDOWS) and files can be organized into directories under this root.

In the illustrative operation, file system management application can operatively manage storage of a file using multiple file systems (e.g., NTFS and LFS) while providing a unified namespace to its users. For example, data store type I 335 can comprise an NTFS file system and data store type II 340 can comprise an LFS (log-structured file system) such that a first file (e.g., \directory1\file1.txt) can be stored on a partition formatted using NTFS and a second file under the same directory (e.g., \directory1\file2.txt) can be stored on a partition formatted using LFS. In the illustrative implementation, application 310 can manage the location of the first and second files with the cooperation of file system management module 315. Illustratively, file system management module 315 can format areas (partitions) of storage using multiple file systems that are optimized for different access patterns or types of files. For example, file system management module 315 can format a partition of storage using a file system that is optimized for small-sized files and another area using a file system that is optimized for large-sized files. Similarly, file system management module 315 could format an area using a file system that is optimized for faster reading of files and another area using a file system optimized for faster writing to files and so on. Furthermore, file system management application can operatively observe one or more operational features representative of one or more properties of the cooperating file systems (e.g., the access patterns and usage pattern of files, the file storage history for a given file or set of files) and select a location to store the first and second files based on the one or more properties. In the illustrative operation, file system management module 315 can also manage the sizes of various partitions based on its observations of storage usage and patterns.

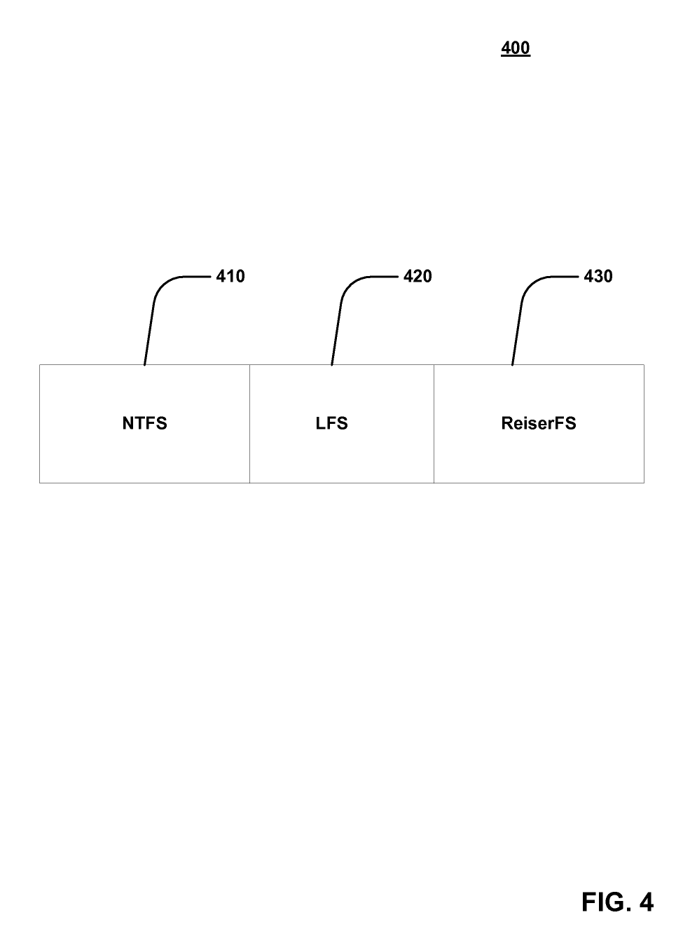

FIG. 4 is a block diagram showing the cooperation of exemplary file systems in an exemplary computing environment 400. As is shown in FIG. 4, exemplary computing environment 400 can, in an illustrative implementation, comprise one or more file systems comprising new technology file system (NTFS) 410, log structured file system (LFS) 420, and Reiser file system (ReiserFS) 430. In an illustrative implementation, a file system management computing application (not shown) can cooperate with one or more of the exemplary file systems 410, 420, and 430 to store and manage a file according to one or more selected criteria based on the properties of the file being stored and/or the properties of the one or more file systems.

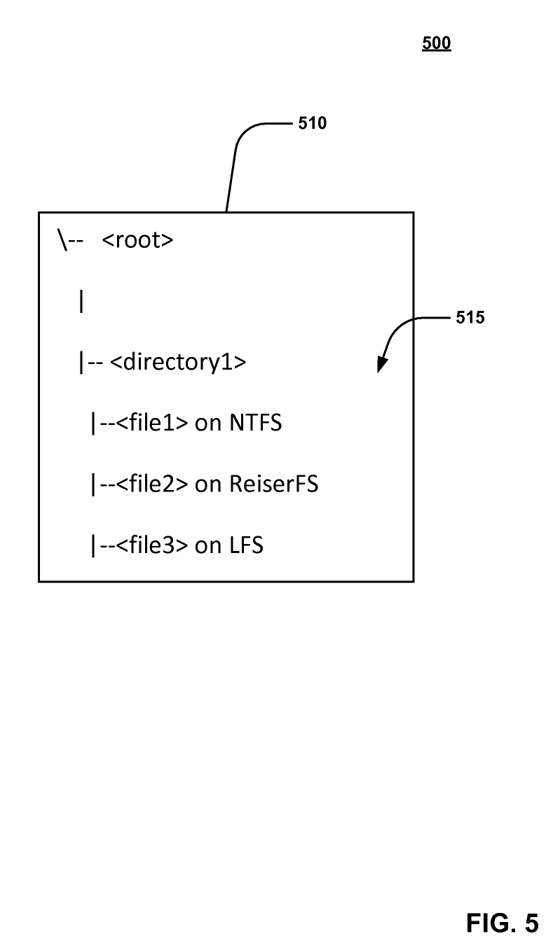

FIG. 5 is a block figure of an exemplary environment 500 comprising display pane 510 of a user interface operable to navigate and display data representative of files that are stored on a computing environment having disparate file systems. As is shown, display pane is operable to display data 515 representative of a file's location on one of the disparate file systems. In an illustrative implementation, display pane 510 can display file storage data 515, for example, file 1 in directory I can be stored on NTFS file system, file 2 in directory 2 can be stored on ReiserFS file system, and file 3 in directory 1 can be stored on LFS file system of exemplary computing environment (e.g., as described by root directory—root).

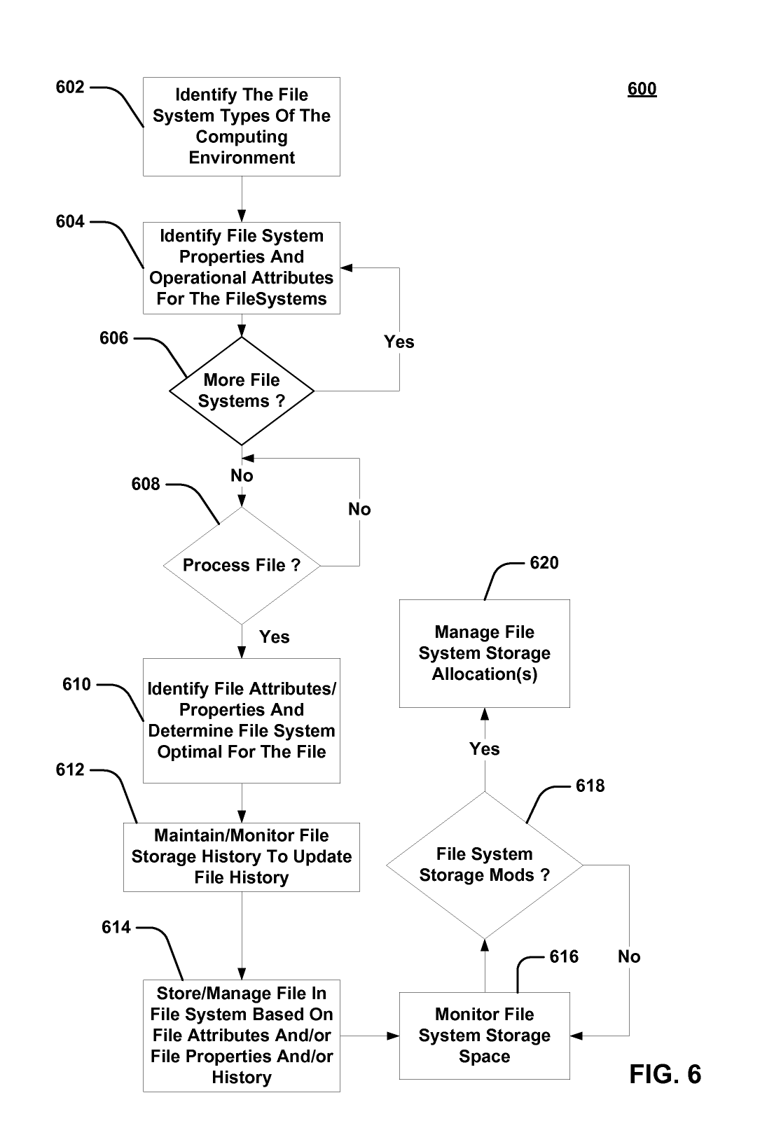

FIG. 6 is a flow diagram of one exemplary method 600 for file management on a computer environment having disparate file systems. As is shown, processing beings at block 602 where the file system types of the computing environment are identified. Processing then proceeds to block 604 where the file system properties and operational attributes are identified. From there, processing proceeds to block 606 where a check is performed to determine if there are additional file systems. If the check at block 606 indicates that there are more file systems operable in the computing environment, processing reverts back to block 604 and proceeds from there.

However, if the check at block 606 indicates that there are no more file systems, processing proceeds to bock 608 where a check is performed to determine if file is to be processed. If the check at block 608 indicates that a file is not to be processed, processing reverts back to the input of block 608. However, if the check at block 608 indicates that the file is to be processed, processing proceeds to block 610 where the attributes/properties of the file (e.g., including but not limited to the file history or history of related or similar type files) to be processed (e.g., stored, moved, monitored, etc.) are identified and a file system optimal for the file is determined. Processing then proceeds to block 612 where the file storage history is maintained/monitored to define and/or update the file history (e.g., file history can contain data of one or more file properties and/or one or more file operational attributes). From there, processing proceeds to block 614 where the file is stored/managed in the file system based on one or more of the file attributes/file properties/file history. The file storage physical space is then monitored at block 616.

A check is then performed at block 618 to determine if one or more storage allocation for the file system storage space is to be changed. If the check at block 618 indicates that there is to be a change to the storage allocation for the file system storage space, processing proceeds to block 620 where the file system storage allocation is managed. However, if the check at block 618 indicates that there is to be no change to the file system allocations of storage space, processing reverts back to 616 and proceeds from there.

In an illustrative implementation, the storage space allocation can be changed according to one or more selected criteria including but not limited to the types of files being stored in the storage space, the file size being stored in the storage space, files system overhead (e.g., a file system attribute), and the operation being performed on the file (e.g., constant editing of a word processing document).

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

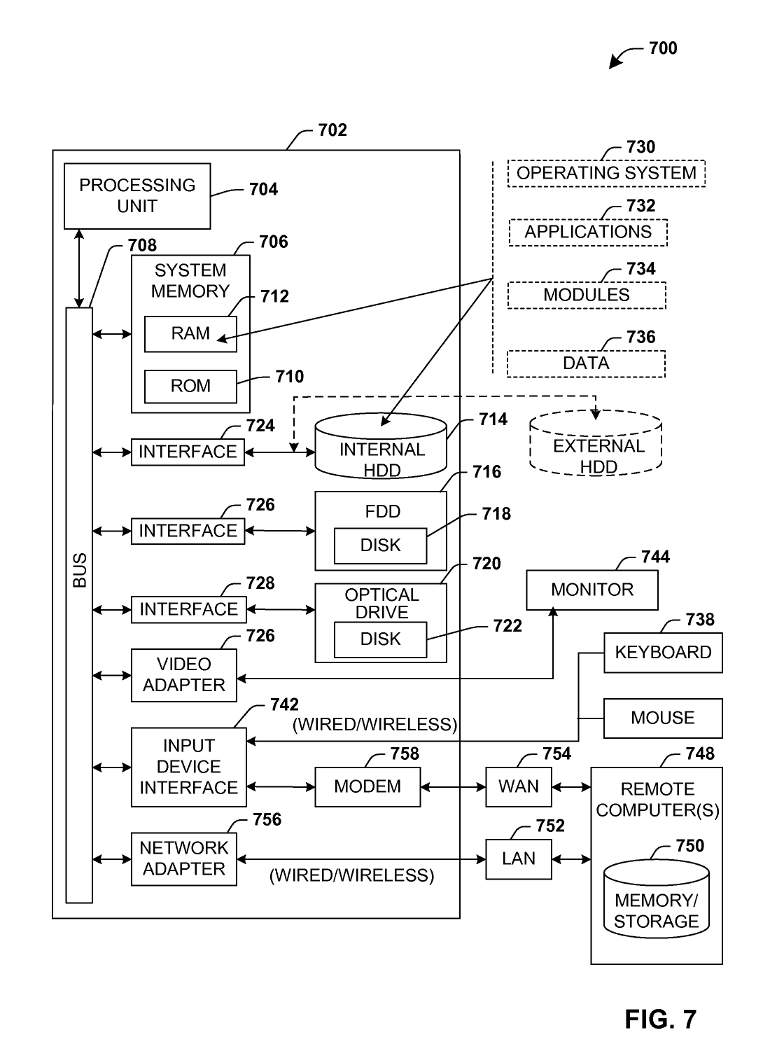

FIG. 7 illustrates a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 7, an example environment 700 for implementing various aspects as described in the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are example and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

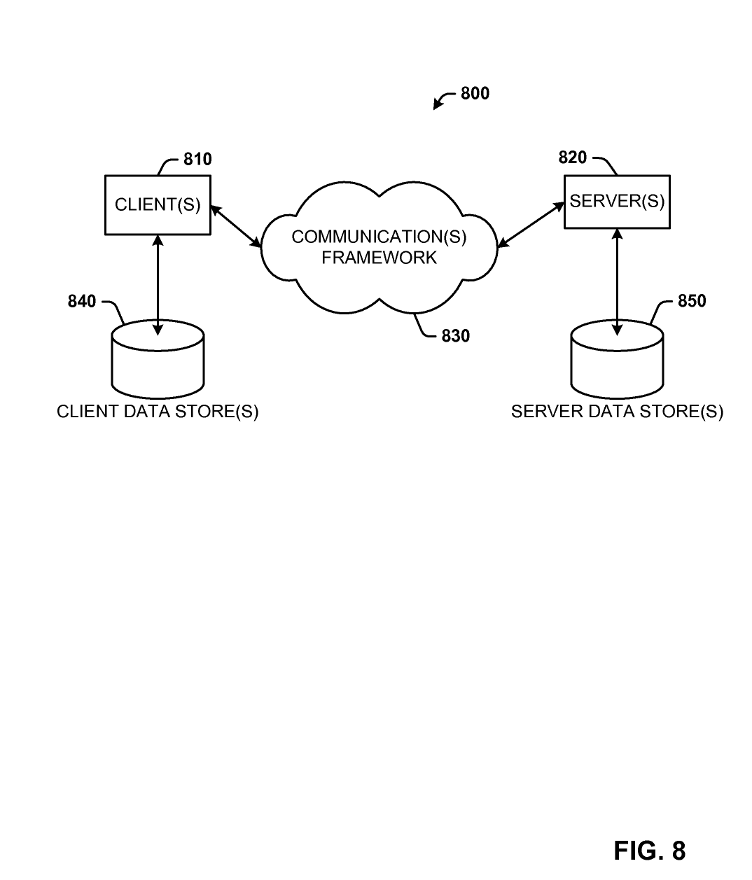

Referring now to FIG. 8, there is illustrated a schematic block diagram of an exemplary computing environment 800 in accordance with the subject invention. The system 800 includes one or more client(s) 810. The client(s) 810 can be hardware and/or software (e.g., threads, processes, computing devices). The client(s) 810 can house cookie(s) and/or associated contextual information by employing the subject invention, for example. The system 800 also includes one or more server(s) 820. The server(s) 820 can also be hardware and/or software (e.g., threads, processes, computing devices). The servers 820 can house threads to perform transformations by employing the subject methods and/or systems for example. One possible communication between a client 810 and a server 820 can be in the form of a data packet adapted to be transmitted between two or more computer processes. The data packet may include a cookie and/or associated contextual information, for example. The system 800 includes a communication framework 830 (e.g., a global communication network such as the Internet) that can be employed to facilitate communications between the client(s) 810 and the server(s) 820.

Communications can be facilitated via a wired (including optical fiber) and/or wireless technology. The client(s) 810 are operatively connected to one or more client data store(s) 840 that can be employed to store information local to the client(s) 810 (e.g., cookie(s) and/or associated contextual information). Similarly, the server(s) 820 are operatively connected to one or more server data store(s) 850 that can be employed to store information local to the servers 820.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system allowing the management and/or storage of a file in a computing environment having one or more disparate file systems comprising:
a file system management computing module operable to cooperating with the computing environment to store, manage, and monitor a file in the computing environment;
an instruction set comprising at least one instruction to instruct the file system management module to generate and/or process one or more attributes of the file according to a selected file system management paradigm,
wherein the file system management paradigm comprises one or more criteria utilized by the file management computing application to determine which of the disparate file systems to use to store the file, the criteria based on one or more observed and/or predicted file properties and/or file operational features,
wherein the file system management module is operable to present the disparate file systems as a single namespace independent of the number of the one or more disparate file systems.

2. The system as recited in claim 1, wherein the file management system module is operable to aggregate and/or predict file property data for use in generating the one or more criteria.

3. The system as recited in claim 1, wherein the one or more file properties comprise file size, file type, and the content of the file.

4. The system as recited in claim 1, wherein the one or more file operational features comprise the frequency the file is accessed by the computing environment and one or more operations being performed on the file by the computing environment.

5. The system as recited in claim 1, further comprising a user interface operable to receive input for processing by the computing environment cooperating with the file system management module for the storage of the file.

6. The system as recited in claim 1, wherein the file system management module is operable to relocate the file from a first file system of the disparate file systems to a second file system of the disparate file systems in accordance with a selected optimization process deployed to improve performance and/or reliability of one or more file access operations.

7. The system as recited in claim 5, wherein the file system management module is operative to select and/or modify the size of the one or more storage partitions of the disparate file systems based on usage of the disparate file systems.

8. The system as recited in claim 1, wherein the file system management paradigm comprises one more properties of the disparate files systems.

9. The system as recited in claim 1, wherein the one or more properties of the disparate file systems comprises operational properties.

10. The system as recited in claim 8, wherein the file system management computing module utilizes the one or more properties of the disparate file systems to determine which of the disparate file systems to store the file.

11. A method to manage the storage of a file on a computing environment having disparate file systems comprising:
receiving data representative of a file;
identifying one or more properties of the file and one or more properties of the disparate file systems;
storing the file to a selected one of the disparate files systems according to a selected one or more properties of the file;
managing the size of storage partitions and/or volumes; and
presenting and maintaining storage location descriptions for the file independent of the location of the stored file.

12. The method as recited in claim 11, further comprising storing the file to a selected one of the disparate file systems according to a selected one or more properties of the disparate file systems.

13. The method as recited in claim 11, further comprising aggregating data representative of the read and/or write and/or access frequency of a file retrieved from the disparate file systems to generate data representative of the one or more properties of the file.

14. The method as recited in claim 11, further comprising determining the size of the file to generate data representative of the one or more properties of the file.

15. The method as recited in claim 11, further comprising determining the file type to generate data representative of the one or more properties of the file.

16. The method as recited in claim 11, further comprising determining one or more operational features of the disparate file systems to generate data representative of the one or more properties of the disparate file systems.

17. The method as recited in claim 11, further comprising determining the file storage and/or read and/or write and/or history of the file.

18. The method as recited in claim 11, further comprising identifying the read and/or write speed by one or more of the disparate file systems.

19. The method as recited in claim 11, further comprising changing the storage allocation space the disparate file systems based the usage of the allocation space.

20. A computer-readable medium having computer executable instructions to instruct a computing environment to perform a method comprising:
receiving data representative of two or more images;
receiving data representative of a file;
identifying one or more properties of the file and one or more properties of the disparate file systems;
storing the file to a selected one of the disparate files systems according to a selected one or more properties of the file; and
displaying the file location of the stored file.
